(19) United States
(12) Patent Application Publication
(10) Pub. No.: US 2014/0375805 A1
(43) Pub. Date: Dec. 25, 2014

(54) CAMERA ASSEMBLY FOR VEHICLE

(71) Applicant: HON HAI PRECISION INDUSTRY CO., LTD., New Taipei (TW)

(72) Inventor: YUH-SHYING GAU, New Taipei (TW)

(21) Appl. No.: 13/924,513

(22) Filed: Jun. 21, 2013

(51) Int. Cl. H04N 7/18

(52) U.S. Cl. CPC H04N 7/18
USPC 348/148

(57) ABSTRACT

A camera assembly includes a camera unit including a lens module, a camera housing accommodating the camera unit, and a vehicle housing disposed on the vehicle. A hanging element and an angle adjustment element are formed on an upper portion and a lower portion of the camera housing respectively. The hanging element is hanged on the vehicle housing and the angle adjustment element is fastened on the vehicle housing. A lens opening is formed between the hanging element and the angle adjustment element to allow the capture of images. The elevation/depression angle of the lens module of the camera unit can be changed by turning the angle adjustment element in or out.

### BACKGROUND

1. Technical Field

The present disclosure relates to a camera assembly, and particularly to a camera assembly for a vehicle.

2. Description of Related Art

In order to record live events, modern event data recorders are equipped with a video camera. Event data recorders for motorcycles are usually equipped with video cameras that are just disposed inside or on the housing of the motorcycle, while event data recorders for cars are usually equipped with video cameras that are disposed near the dashboard of the car. Hence, the video cameras are usually not convenient for reaching and configuring, and their view angles are not easy to adjust when frequent adjustments are needed, such as (particularly in the case of motorcycles) when they are subject to frequent shocks.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic diagram of an embodiment of a camera assembly of the present disclosure disposed on a vehicle.

FIG. 2 is a block diagram of an embodiment of the camera assembly shown in FIG. 1.

FIG. 3A/3B are schematic diagrams of an embodiment of the camera assembly shown in FIG. 1.

FIG. 4 is a schematic diagram of the camera housing shown in FIG. 1 installed on a vehicle housing of the vehicle shown in FIG. 1.

### DETAILED DESCRIPTION

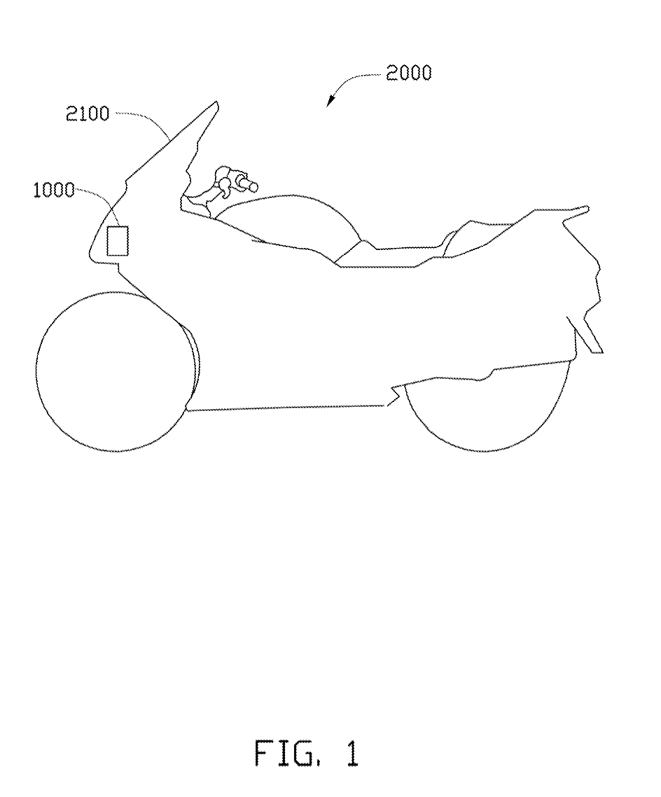

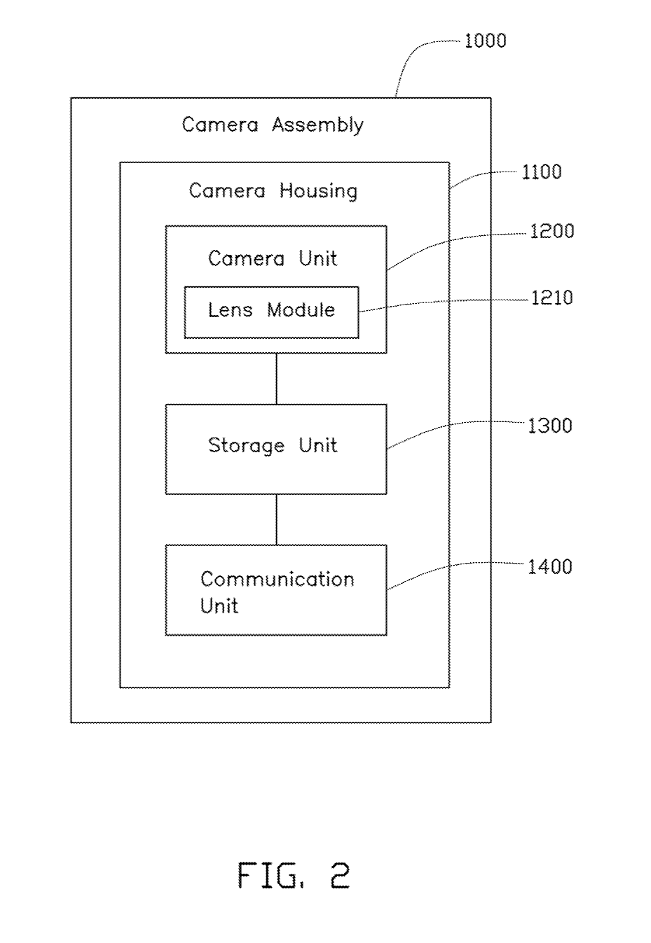

FIG. 1 is a schematic diagram of an embodiment of a camera assembly 1000 of the present disclosure disposed on a vehicle 2000. In the illustrated embodiment, the camera assembly 1000 is disposed on a vehicle 2000 to act as an event data recorder, where the vehicle 2000 is a motorcycle with a vehicle housing 2100 accommodating the camera assembly 1000. In other embodiments, the camera assembly 1000 can be disposed on other types of vehicle such as bicycles or cars.

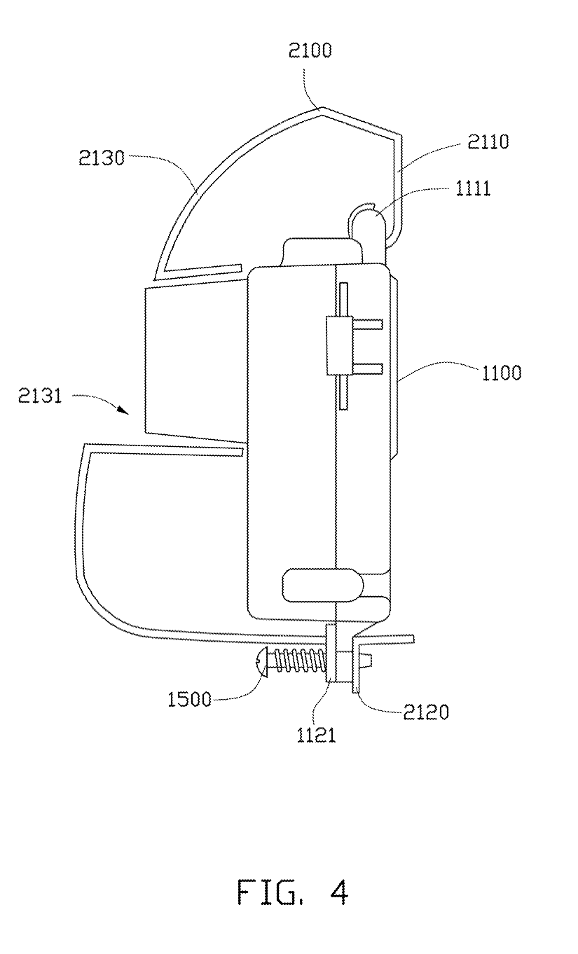

FIG. 2 is a block diagram of an embodiment of the camera assembly 1000 shown in FIG. 1. The camera assembly 1000 includes a camera housing 1100, a camera unit 1200, a storage unit 1300, and a communication unit 1400 (see FIG. 4). The camera housing 1100 is fixed on the vehicle housing 2100 of the vehicle 2000. The camera housing 1100 accommodates the camera unit 1200, the storage unit 1300, and the communication unit 1400. The camera unit 1200 includes a lens module 1210. The lens module 1210 includes, for example, a lens and a circuit board capable of controlling the lens. The camera unit 1200 captures images. In the illustrated embodiment, the camera unit 1200 includes a camera (video camera) capable of capturing moving images such as videos. In other embodiments, the camera unit 1200 can include a camera capable of capturing still photographs and motion pictures. The storage unit 1300 may include a device such as a high speed random access memory, a non-volatile memory, or a hard disk drive for storing and retrieving digital information, to store event data of the vehicle 2000, such as the images produced by the camera unit 1200 and the parameters of the vehicle 2000 such as the braking status, the speed, the engine oil pressure, the engine temperature, the inclination angle, and its location, all of which are received from the vehicle 2000 or sensors disposed on it.

The communication unit 1400 provides communication functionality between the camera unit 1200 and an external electronic device, such as a dashboard device of the vehicle 2000, a portable electronic device such as a smartphone or tablet computer, or a server. Hence, the external electronic device can configure the camera unit 1200 or access the event data of the vehicle 2000 stored in the storage unit 1300 through the communication unit 1400. When the external electronic device is a server, the images and the parameters can be transmitted to the server in real time for storage in the server, thereby recording the event data of the vehicle 2000. The communication unit 1400 may include a wired communication unit such as a universal serial bus (USB) interface or a wireless communication unit such as a WIFI interface.

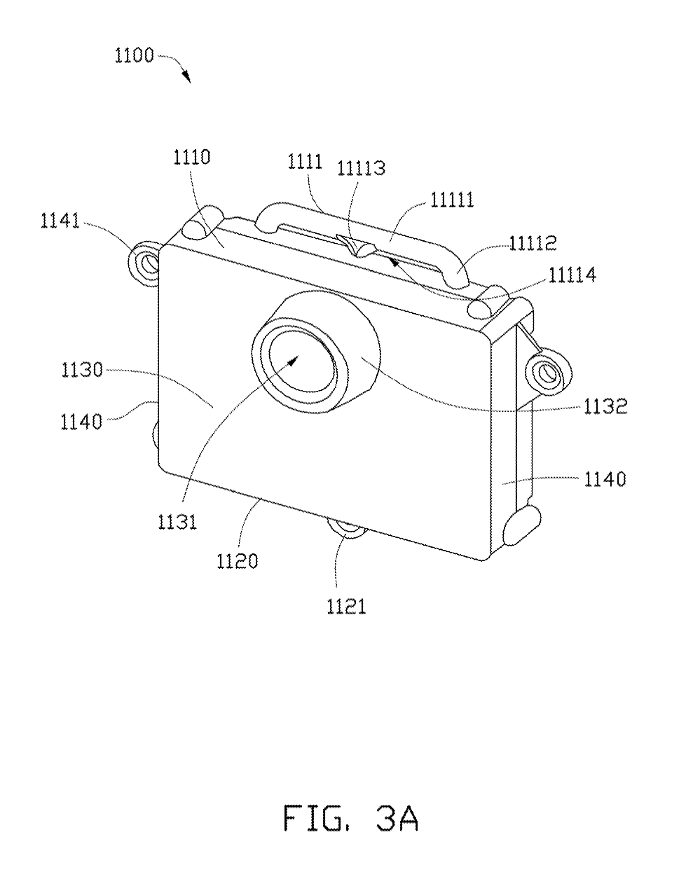

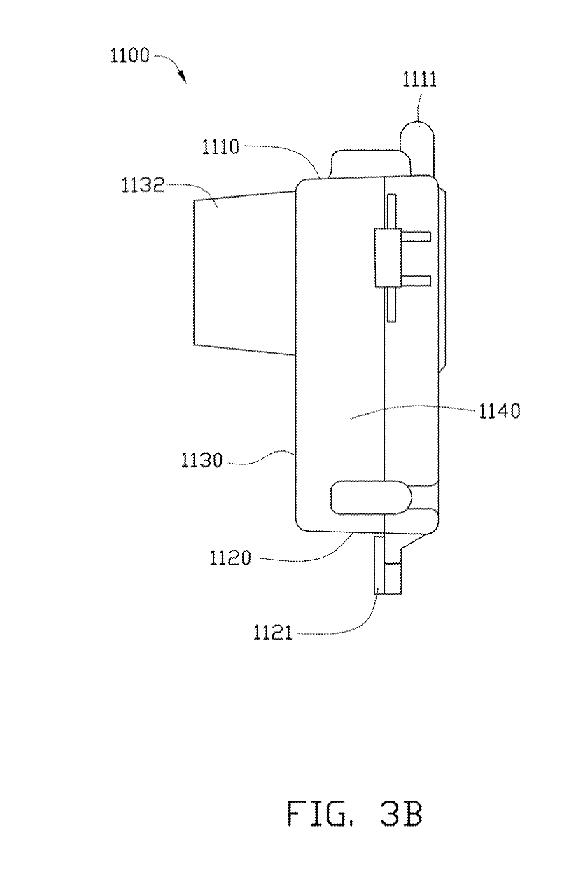

FIG. 3A/3B are schematic diagrams of an embodiment of the camera assembly 1000 shown in FIG. 1. The camera housing 1100 includes a top wall 1110 on an upper portion of the camera housing 1100, a bottom wall 1120 on a lower portion of the camera housing 1100, a front wall 1130 between the top wall 1110 and the bottom wall 1120, and two side walls 1140 between two opposite edges of the front wall 1130 and the top wall 1110. A hanging element 1111 is formed on and extends from the top wall 1110.

In the illustrated embodiment, the hanging element 1111 includes a handle portion 11111, two connection portions 11112, and a separation portion 11113. The handle portion 11111 has a cylindrical structure, and is disposed on the surface of the top wall 1110 to create a space between the handle portion 11111 and the top wall 1110. The connection portions 11112 attach the handle portion 11111 to the surface of the top wall 1110, such that the handle portion 11111 is in parallel to the front wall 1130. The separation portion 11113 is attached between a central position of the handle portion 11111 and the surface of the top wall 1110, thereby defining two orifices or gaps (hanging holes 11114) to suspend the camera housing 1100.

A first fastener unit 1121 is a fastening element with a fastener hole, such as a screw plate with a screw hole. A single first fastener unit 1121 extends from the bottom wall 1120. A fastener unit 1141 is a fastening element with a fastener hole, such as a screw plate with a screw hole, and a fastener element 1141 is formed on each of the two side walls 1140 to extend from the side walls 1140. In other embodiments, the hanging element 1111 can be formed as other shapes, such as ring-shaped or hook-shaped, and the first fastener unit 1121 and/or the fastener unit 1141 can be a fastener such as a screw.

A lens opening 1131 is defined on the front wall 1130 and located between the two fastener units 1141 and centrally under the hanging element 1111. The lens opening 1131 exposes the lens module 1210 of the camera unit 1200 to the environment outside the camera assembly 1000, such that the lens module 1210 can capture images. A lens wall 1132 is formed perpendicular to the front wall 1130 perpendicular to the top wall 1110 to extend along the rim of the lens opening 1131. In the illustrated embodiment, the hanging element 1111, the first fastener unit 1121, the lens wall 1132, and the fastener unit 1141 are molded onto the camera housing 1100. In other embodiments, the hanging element 1111, the first fastener unit 1121, the lens wall 1132, and the fastener unit 1141 are individual or non-integral elements installed on the camera housing 1100.

FIG. 4 is a schematic diagram of the camera housing 1100 shown in FIG. 1 installed on the vehicle housing 2100 of the vehicle 2000 shown in FIG. 1. In the illustrated embodiment, the vehicle housing 2100 is a front housing of the vehicle 2000, such as a windshield, which is disposed between the controller and the front wheel(s) of the vehicle 2000. In other embodiments, the vehicle housing 2100 can be another type of housing of the vehicle 2000 such as a controller housing. The vehicle housing 2100 includes a hanging element 2110 and a second fastener unit 2120. The camera housing 1100 is hung on the hanging element 2110 of the vehicle housing 2100 by the hanging element 1111 of the camera housing 1100. In the illustrated embodiment, the hanging element 2110 includes two hooks that extend through the two hanging holes 11114 and suspend the camera housing 1100 stably while allowing a degree of rotation around the two hooks.

A camera opening 2131 is defined on an inclined surface 2130 of the vehicle housing 2100 between the hanging element 2110 and the second fastener unit 2120. The lens opening 1131 and the camera opening 2131 are aligned with each other to expose the external environment to the lens module 1210 of the camera unit 1200, such that the lens module 1210 can capture images.

Since the camera housing 1100 is suspended by the hanging element 1111, the elevation/depression angle of the lens module 1210 can be changed through screwing in or screwing out the first fastener unit 1121 on the lower portion of the camera housing 1100, thereby changing the inclination angle of the camera housing 1100. The first fastener unit 1121 can be fastening elements with a fastener hole or can be fasteners, and the second fastener unit 2120 can be fastening elements with a fastener hole or can be fasteners. In the illustrated embodiment, the first fastener unit 1121 and the second fastener unit 2120 are screw plates with a screwed hole. The inclination angle is changed by changing the fastening depth of a fastener 1500, such as a screw or a rivet, with respect to the first fastener unit 1121 when the first fastener unit 1121 is fastened on the second fastener unit 2120, although leaving a stable three-point support for the camera housing 1100. The maximum range of the elevation/depression angle is within 15 degrees. In other embodiments, the first fastener unit 1121 and the second fastener unit 2120 can be rivet plates with a rivet hole, or fasteners such as screws or rivets.

Furthermore, in other embodiments, the hanging element 1111 can be disposed on another part of the camera housing 1100. For instance, the hanging element 1111 can be disposed on the top of a back wall (which is parallel to the front wall 1130) of the camera housing 1100, while the first fastener unit 1121 can be disposed on the bottom of the front wall 1130. In addition, other types of angle adjusting elements can be used instead of the first fastener unit 1121 and the second fastener unit 2120. For instance, an expandable mechanism such as a telescopic pole can substitute for the second fastener unit 2120, while the back wall of the camera housing 1100 can substitute for the first fastener unit 1121, such that the inclination angle of the camera housing 1100 can be changed by using the expandable mechanism to push/pull the back wall, thereby changing the elevation/depression angle of the lens module 1210.

The camera assembly provides a mechanism capable of changing the elevation/depression of a camera disposed on a vehicle by hanging the camera on a housing of the vehicle by using a fastener as an adjuster as well as a supporter, to provide a simple way to change the elevation/depression of the camera disposed on the vehicle. This is especially suitable for a motorcycle with an inclined front housing.

While the disclosure has been described by way of example and in terms of a preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A camera assembly for a vehicle, the camera assembly comprising:
a camera unit comprising a lens module; and
a camera housing accommodating the camera unit, comprising:
a hanging element on an upper portion of the camera housing; and
an angle adjustment element on a lower portion of the camera housing;
wherein a lens opening is defined between the hanging element and the angle adjustment element of the camera housing, the lens opening exposes the lens module of the camera unit, the elevation/depression angle of the lens module of the camera unit is selectively changed through the angle adjustment element when the camera housing is hanged through the hanging element.

2. The camera assembly of claim 1, wherein the elevation/depression angle of the lens module of the camera unit is changed through changing the support angle of the angle adjustment element of the camera housing.

3. The camera assembly of claim 2, wherein the angle adjustment element comprises a fastener unit, the support angle of the angle adjustment element is changed by changing the fastening depth of a fastener with respect to the fastener unit.

4. The camera assembly of claim 3, wherein the fastener unit comprises a fastener hole.

5. The camera assembly of claim 1, wherein the hanging element of the camera housing comprises a ring-shaped mechanism or a hook-shaped mechanism.

6. The camera assembly of claim 1, wherein the camera housing comprises a top wall on the upper portion of the camera housing, a bottom wall on the lower portion of the camera housing, and a front wall between the top wall and the bottom wall, the hanging element extends from the top wall, the angle adjustment element extends from the bottom wall, the lens opening is defined on the front wall.

7. The camera assembly of claim 6, wherein the camera housing comprises two side walls between two opposite edges of the front wall, each of the side walls comprises a third fastener unit.

8. The camera assembly of claim 1, wherein the camera housing comprises a lens wall extending along the rim of the lens opening of the camera housing.

9. A camera assembly for a vehicle, the camera assembly comprising:
a camera unit comprising a lens module;
a camera housing accommodating the camera unit, comprising:
a first hanging element on an upper portion of the camera housing; and
a first angle adjustment element on a lower portion of the camera housing; and
a vehicle housing disposed on the vehicle, comprising:
a second hanging element;
wherein a lens opening is defined between the hanging element and the first angle adjustment element of the camera housing, a camera opening is defined on the vehicle housing, the lens opening and the camera opening are aligned with each other to expose the lens module of the camera unit, the camera housing is hanged on the second hanging element of the vehicle housing through the first hanging element of the camera housing, the elevation/depression angle of the lens module of the camera unit is selectively changed through the first angle adjustment element.

10. The camera assembly of claim 9, wherein the elevation/depression angle of the lens module of the camera unit is changed through changing the support angle of the first angle adjustment element of the camera housing.

11. The camera assembly of claim 10, wherein the first angle adjustment element comprises a first fastener unit, the vehicle housing comprises a second fastener unit, the support angle of the first angle adjustment element is changed by changing the fastening depth of a fastener with respect to the first fastener unit when the first fastener unit is fastened on the second fastener unit.

12. The camera assembly of claim 11, wherein the first fastener unit comprises a first fastener hole, the second fastener unit comprises a second fastener hole.

13. The camera assembly of claim 10, further comprising an expandable mechanism, wherein the support angle of the first angle adjustment element is changed by pushing/pulling the first angle adjustment element through the expandable mechanism.

14. The camera assembly of claim 9, wherein the first hanging element of the camera housing comprises a ring-shaped mechanism or a hook-shaped mechanism.

15. The camera assembly of claim 9, wherein the second hanging element of the vehicle housing comprises a ring-shaped mechanism or a hook-shaped mechanism.

16. The camera assembly of claim 9, wherein the camera housing comprises a top wall on the upper portion of the camera housing, a bottom wall on the lower portion of the camera housing, and a front wall between the top wall and the bottom wall, the first hanging element extends from the top wall, the first angle adjustment element extends from the bottom wall, the lens opening is defined on the front wall.

17. The camera assembly of claim 16, wherein the camera hosing comprises two side walls between two opposite edges of the front wall of the camera housing, each of the side walls comprises a third fastener unit.

18. The camera assembly of claim 9, wherein the camera housing comprises a lens wall extending along the rim of the lens opening of the camera housing.

19. The camera assembly of claim 9, wherein the vehicle is a motorcycle, the vehicle housing includes a front housing of the motorcycle.

20. The camera assembly of claim 9, wherein the vehicle is a motorcycle, the vehicle housing includes a controller housing of the motorcycle.
